(19) United States
(12) Patent Application Publication
(10) Pub. No.: US 2005/0238253 A1
(43) Pub. Date: Oct. 27, 2005

(54) Image registration

(75) Inventors: Christian Peter Behrenbruch, Oxford (GB); Jerome Marie Joseph Declerck, Oxford (GB)

Correspondence Address: KALOW & SPRINGUT LLP, 488 MADISON AVENUE, 19TH FLOOR, NEW YORK, NY, 10022, US

(73) Assignee: Mirada Solutions Limited British body corporate, Oxford (GB)

(21) Appl. No.: 10/502,034

(22) PCT Filed: Sep. 18, 2003
(86) PCT No.: PCT/GB03/04021

§ 371 Date: Jul. 19, 2004

(30) Foreign Application Priority Data
Nov. 29, 2002 (GB) 0227887.7

(51) Int. Cl. G06K 9/32; G06K 9/00

(52) U.S. Cl. 382/294; 382/128

(57) ABSTRACT

A method of displaying two images in registration with each other in which a visually distinguishable overlay is also displayed to represent the degree of “confidence” in the registration process. The degree of confidence may be calculated on the basis of the degree of non-rigid deformation needed to register the two images. The visually distinguishable overlay can be in the form of a transparent color wash whose color and/or intensity indicate the level of confidence, or a symbol, e.g. a circle, whose size represents the degree of confidence.

The present invention relates to the registration of images, that is to say the process in which two different images are compared to find how they match each other, and are then displayed superimposed one on the other.

The registration of different images (also often called fusion of images) is useful in a variety of fields. The images being compared and superimposed could be images of the same object acquired using different modalities, which thus show up different features of interest. The fact that different features of interest are shown by the two modalities is useful in itself, but the usefulness can be enhanced by displaying the two images in superimposition. Examples of this technique might be the fusion of an infrared image with a visible light image, for instance in a surveillance, mapping or medical situation, or, particularly in the medical field, the combination of two different modality images such as magnetic resonance images, nuclear medicine images, x-ray images, ultrasound images etc. In general this fusion of different images assists the interpretation of the images.

In some situations the two images to be fused are taken at same time, or nearly the same time, but in other situations it is useful to fuse images taken at different times. For example, in the medical field it may be useful to fuse an image taken during one patient examination with an image taken in a different examination, for instance six months or a year spaced from the first one. This can assist in showing the changes in the patient's condition during that time. The fusion of time-separated images arises also in many other fields, such as surveillance and mapping.

A typical registration (or fusion) technique relies on identifying corresponding points in the two images and calculating a transformation which maps the pixels of one image to the pixels of another. This may use, for example, the well known block matching techniques in which pixels in a block in one image frame are compared with pixels in corresponding blocks in a search window in the other image frame and the transformation is calculated which minimises a similarity measure in the intensities in the blocks, such as the sum of square difference. Other techniques based on identification of corresponding shapes in the two images have also been proposed. Explanations of different registration techniques are found in, for example, U.S. Pat. No. 5,672,877 (ADAC Laboratories), U.S. Pat. No. 5,871,013 (Elscint Limited), and many other text books and published papers.

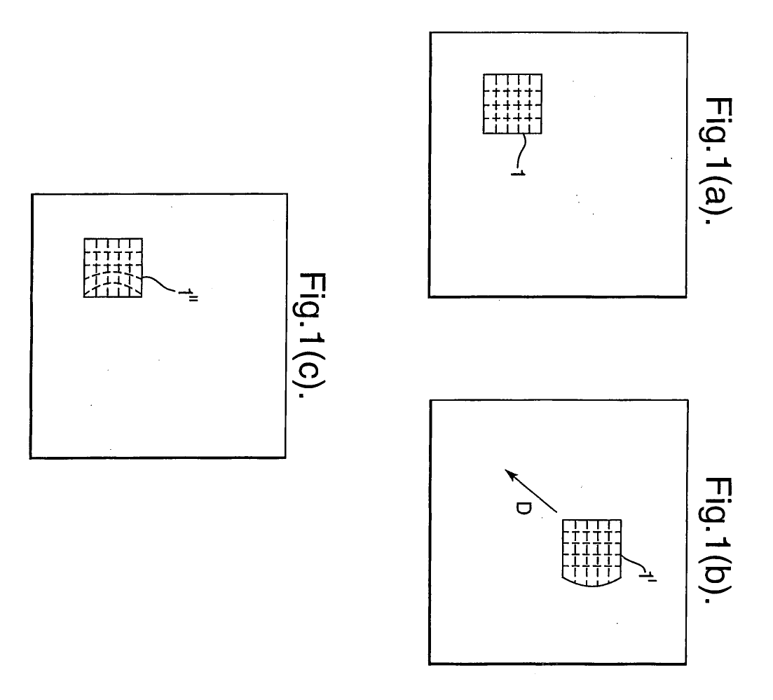

While such registration techniques are useful, the results can be regarded with suspicion by users. This is particularly true where the transformation which maps features in one image to features in the other involves not only a rigid movement, but also a non-rigid deformation of the image features. Users are typically prepared to accept the validity of a rigid movement, such as a translation and/or rotation, between two different images, but the validity of a shape deformation is much less clear. FIG. 1 of the accompanying drawings illustrates schematically a typical situation. An image feature 1 in image frame (a) is found to match an image feature 1′ in another image frame (b). To map the feature 1′ to the original feature 1 it is necessary to perform a rigid displacement in the direction of arrow D in image (b), but it can be seen that there is also a shape change required because the right hand side of the object is stretched in image (b). Combining the rigid displacement and the deformation results in the fused image (c), but it can be seen that there is a resulting deformation field in the right hand part of the feature 1″ in the fused image (c). Particularly in the medical field the concept of deformation like this is regarded with great scepticism by clinicians as they fear the consequences of an erroneous distortion: a stretched or shrunk functional image could lead the clinician to under- or over-estimate the extent of a diseased area, and lead to an inappropriate treatment with potentially dramatic consequences.

The present invention provides an image registration, or fusion, method in which a confidence measure can also be displayed to the user to give the user an idea of the quality of registration. This confidence measure is calculated from the registration process. The measure of confidence can be, for example, the degree of transformation required to perform the mapping, and preferably be based on the degree of non-rigid deformation in the transformation. Thus the confidence measure may exclude rigid motions and represent only the magnitude of the local deformation. The measure can also be based on the local change of volume implied by the mapping transformation from one image to the other.

The measure may be selectively displayed in response to user input. It may be displayed as a visually distinguishable overlay on the display of the fused images. It may comprise a colour overlay with the colour or intensity (or both) indicating the measure of confidence, or the same could be achieved with a monochrome overlay whose grey level represents the measure. Alternatively, a symbol, such as a circle, can be displayed at any selected point in the fused image, whose size and/or shape, for instance the diameter of the circle, is measure of the confidence in the registration. Clearly a number or another symbol could be chosen and another attribute, e.g. colour, rather than size, used to indicate the confidence measure. Preferably, to avoid cluttering the display, the symbol is only displayed at a single point selected by the user, for example by setting the cursor at that position, possibly in response to the user “clicking” at the selected point on the screen.

However the confidence measure is displayed, it need not be on the fused image, but can be next to it, or in a separate display window, or on a copy of the fused image. For example an error bar or number corresponding to the confidence measure at the cursor position would be displayed alongside the fused image.

The method is particularly applicable to fused medical images, though it is also applicable in other fields where images are registered, such as surveillance, mapping etc.

The invention may conveniently be embodied as a computer program comprising program code means for executing the method, and the invention extends to a storage or transmission medium encoding the program and to an image processing and display apparatus which performs the method.

The invention will be further described by way of example with reference to the accompanying drawings, in which:—

FIG. 1 is a schematic diagram of an image registration or fusion process;

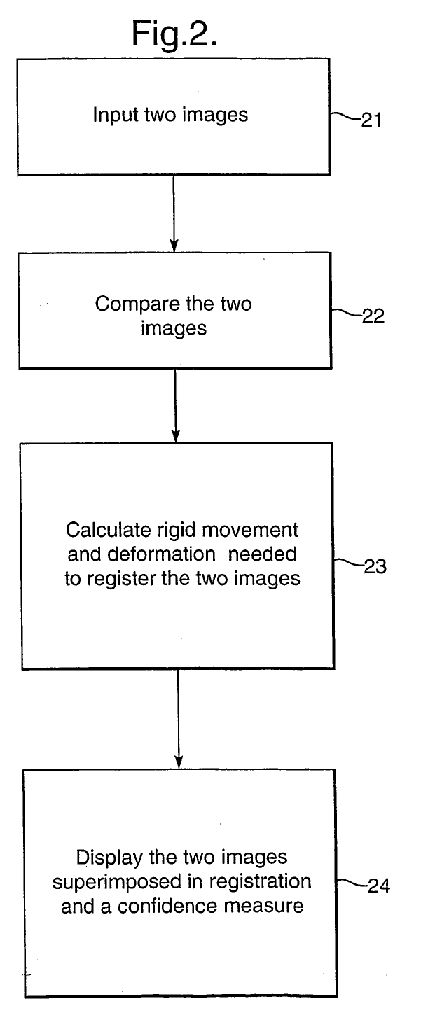

FIG. 2 is a flow diagram of an embodiment of the invention;

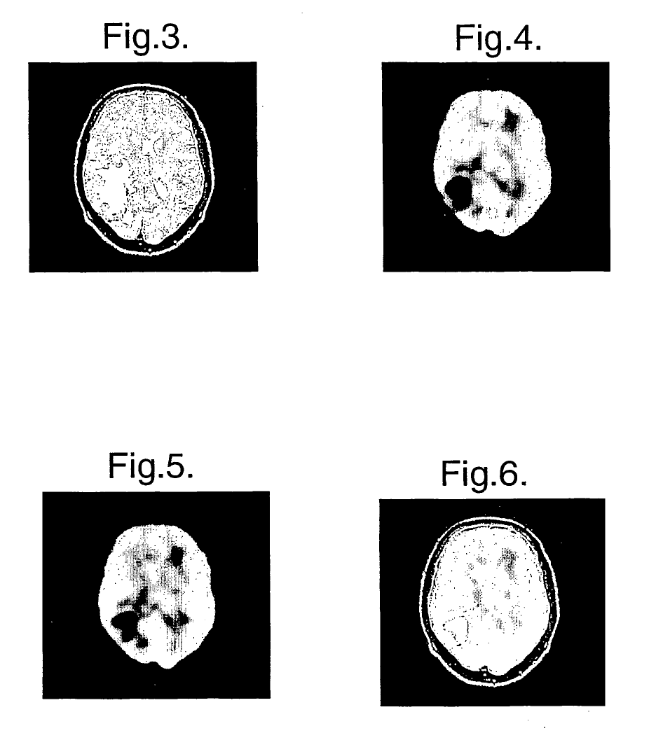

FIG. 3 illustrates an original MR image of the brain;

FIG. 4 illustrates an original PET image of the brain;

FIG. 5 illustrates the result of applying a non-rigid transformation to the PET image of FIG. 4 so that it will register with the MR image of FIG. 3;

FIG. 6 illustrates the original MR image superimposed with the deformed PET image in registration with it;

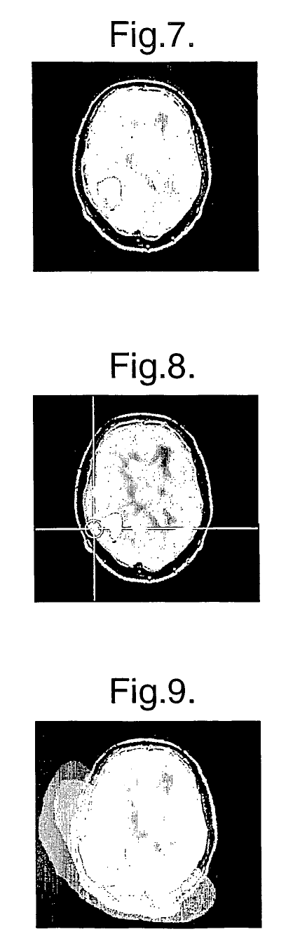

FIG. 7 illustrates the result of applying only a rigid transformation to the PET image of FIG. 4 so that it will register with the MR image of FIG. 3;

FIG. 8 illustrates a display of a fused image in accordance with one embodiment of the invention; and

FIG. 9 illustrates a display of a fused image in accordance with another embodiment of the invention.

As indicated in FIG. 2 a typical image fusion or registration process involves at step 21 the input of two images. These may be individual image frames in static imaging, or could be image sequences in a dynamic imaging application. The two images are compared in step 22 and the transformation which best maps features from one image onto corresponding features of the other is calculated. This transformation is, in essence, a mapping of pixels in one image to pixels in the other. Taking, as an example, a three dimensional image this may be expressed as:—
(x₁,y₁,z₁)=RIG(x₂,y₂,z₂)+DEF(x₂,y₂,z₂) (1)
where F represents the mapping transformation. Typically this transformation may include a rigid movement and a deformation viz:—
   (xₗ,y₁,z₁)=F(x₂,y₂,z₂) (2)

The rigid part of the movement may be a translation and a rotation, namely:—
(x₁y₁,z₁)=TRANS(x₂,y₂,z₂)+ROT(x₂,y₂,z₂)+DEF(x₂,y₂,z₂) (3)

FIGS. 3, 4, 5 and 6 illustrate an example of this method applied to brain imaging. FIGS. 3 and 4 illustrate respectively the original MR and PET images of the brain. FIG. 5 illustrates the result of applying a non-rigid transformation to the PET image of FIG. 4 so that it will register with the MR image of FIG. 3 and FIG. 6 illustrates the original MR image superimposed with the deformed PET image in registration with it. The advantages of being able to see at a glance the information from both imaging modalities are clear. By way of a comparison, FIG. 7 illustrates the result of superimposing a version of the PET image of FIG. 4 onto the MR image of FIG. 3 with only a rigid deformation.

In accordance with this embodiment of the invention the size of the deformable part of the transformation DEF is regarded as a measure of the disagreement between the rigid registration (RIG) and the deformable registration (RIG+DEF). Thus a confidence measure M is calculated from the deformable part of the transformation. As one example the confidence measure M may be simply the magnitude (norm) of the local displacement. That is to say:—
M=|DEF(x₂,y₂,z₂)| (4)

Alternatively, the confidence measure may be calculated as the determinant of the local Jacobian of the transformation, which defines the local stretching (change of volume) at a particular location. So if:—
x₁=Fₓ(x₂,y₂,z₂)
y₁=F_{y}(x₂,y₂,z₂)
z₁=F_{z}(x₂,y₂,z₂) (5)

Then the measure M becomes:—

$$M = \vert \begin{matrix}\frac{ⅆ {F}_{x}}{ⅆ x} & \frac{ⅆ {F}_{x}}{ⅆ y} & \frac{ⅆ {F}_{x}}{ⅆ z} \\ \frac{ⅆ {F}_{y}}{ⅆ x} & \frac{ⅆ {F}_{y}}{ⅆ y} & \frac{ⅆ {F}_{y}}{ⅆ z} \\ \frac{ⅆ {F}_{z}}{ⅆ x} & \frac{ⅆ {F}_{z}}{ⅆ y} & \frac{ⅆ {F}_{z}}{ⅆ z}\end{matrix} \vert \qquad ( 6 )$$

It is also possible to base the measure on the value of the similarity function such as cross-correlation, mutual information, correlation ratio or the like (see for example A. Roche, X. Pennec, G. Malandain, and N. Ayache. Rigid Registration of 3D Ultrasound with MR Images: a New Approach Combining Intensity and Gradient Information. IEEE Transactions on Medical Imaging, 20(10):1038—1049, October 2001) used in matching local blocks in the images, or to combine these various measure together to form a normalised estimate of the “confidence” in the registration process.

Once the measure has been calculated it can be displayed over the fused image. One way of displaying it is, in response to the user “clicking” at a certain point on the display, to display a circle whose diameter represents the value of the confidence measure. FIG. 8 illustrates this applied to the fused image of FIG. 6. The user can “point” to different positions on the image using the perpendicularly-intersecting cross-hairs (typically controlled by a pointing device such as a computer mouse), and “clicking” at the selected position causes a circle to be displayed as shown. The larger the circle the more non-rigid deformation has occurred and so the less agreement there is between the rigid and non-rigid registration. Thus the more careful the clinician should be while reviewing this fusion result. On the other hand, in areas where the circle has a small diameter, the registration has been basically a rigid movement, and thus the result of the fusion can be regarded as more reliable.

FIG. 9 shows an alternative way of displaying the confidence measure on the fused image of FIG. 6. In FIG. 9 the overlay is a transparent colour wash (though shown in black and white in FIG. 9) whose colour and intensity are directly related to the value of the confidence measure. For example, green of low intensity may be used where the confidence is high (i.e. the amount of non-rigid deformation is low) whereas red, growing more intense, can be used as the amount of non-rigid deformation increases. It can be seen that the confidence decreases towards the left of the image where a high non-rigid deformation was required to register the two images.

1. A method of displaying two images in registration with each other comprising the steps of comparing the two images to each other, calculating a transformation which maps features in one image to corresponding features in the other, displaying the two images in superimposition based on the transformation, and displaying a measure of the confidence in the registration.

2. A method according to claim 1 wherein said measure of confidence is calculated from the degree of transformation required to perform said mapping.

3. A method according to claim 2 wherein said measure of confidence is calculated from the degree of non-rigid deformation in said calculated transformation.

4. A method according to claim 2 wherein said measure is calculated excluding rigid motions.

5. A method according to claim 2 wherein said measure of confidence is calculated from the magnitude of the local deformation in said transformation.

6. A method according to claim 2 wherein said measure of confidence is calculated from the local change of volume implied by the transformation

7. A method according to claim 1 wherein the measure is selectively displayed in response to user input.

8. A method according to claim 1 wherein the confidence measure is displayed overlaid on the two images.

9. A method according to claim 1 wherein the measure is displayed as a visually distinguishable overlay on the two images, the visual properties of the overlay at any point being based on the said measure.

10. A method according to claim 9 wherein the colour of the visually distinguishable overlay is varied in dependence on said measure.

11. A method according to claim 9 wherein the intensity of the visually distinguishable overlay is varied in dependence on said measure.

12. A method according to claim 9 wherein the grey-level of the visually distinguishable overlay is varied in dependence on said measure.

13. A method according to claim 8 wherein the confidence measure is displayed next to the displayed superimposed images.

14. A method according to claim 8, wherein the visually distinguishable overlay comprises a symbol having a property which depends on the value of said measure at a selected display point.

15. A method according to claim 14 wherein the symbol is one of a circle and an error bar whose size depends on the value of said measure at a selected display point.

16. A method according to claim 14 wherein the symbol is displayed at any time only at a single selected display point.

17. A method according to claim 1 wherein the images are medical images.

18. A computer program comprising program code means for executing on a programmed computer the method of claim 1.

19. A computer-readable storage medium encoding a computer program in accordance with claim 18.

20. An image display apparatus comprising a display, and an image processor adapted to perform the method of claim 1.
